(19) United States
(12) Patent Application Publication
(10) Pub. No.: US 2026/0239081 A1
(43) Pub. Date: Aug. 13, 2026

(54) METHOD FOR REPORTING CHANNEL STATE INFORMATION AND COMMUNICATION APPARATUS

(71) Applicant: BEIJING XIAOMI MOBILE SOFTWARE CO., LTD., Beijing (CN)

(72) Inventors: Zhengxuan LIU, Beijing (CN); Min LIU, Beijing (CN)

(73) Assignee: BEIJING XIAOMI MOBILE SOFTWARE CO., LTD., Beijing (CN)

(21) Appl. No.: 19/470,974

(22) PCT Filed: Apr. 6, 2023
(86) PCT No.: PCT/CN2023/086713

§ 371 Date: Sep. 30, 2025

(51) Int. Cl. H04W 24/10

(52) U.S. Cl. CPC H04W 24/10

(57) ABSTRACT

A method for reporting CSI and a communication apparatus are provided. The method includes: obtaining first CSI and second CSI to be reported; determining a reporting priority order of at least part of the first CSI and the second CSI; an performing a CSI reporting according to the reporting priority order

### CROSS-REFERENCE TO RELATED APPLICATIONS

The present application is a U.S. national phase of International Application No. PCT/CN2023/086713, filed on Apr. 6, 2023, the entire content of which is incorporated herein by reference for all purposes.

### FIELD

The present disclosure relates to the field of communication technologies, and in particular, to a method for reporting CSI and an apparatus therefore.

### BACKGROUND

A terminal device may not only obtain Channel State Information (CSI) through traditional methods and report the CSI obtained through traditional methods to a network device, but may also obtain CSI through Artificial Intelligence (AI) and report the CSI obtained based on AI methods to the network device.

In practical applications, during the process of reporting CSI to the network device, if there is a collision or conflict between the CSI obtained based on AI methods and the CSI obtained through traditional methods, how to reasonably report the CSI becomes a problem that needs to be solved.

### SUMMARY

In a first aspect, an embodiment of the present disclosure provides a method for reporting CSI, where the method includes:
obtaining first CSI and second CSI to be reported;
determining a reporting priority order of at least part of the first CSI and the second CSI; and
performing CSI reporting according to the reporting priority order.

In a second aspect, an embodiment of the present disclosure provides another method for reporting CSI, where the method includes:
receiving CSI reported by a terminal device based on a reporting priority order, where the reported CSI is at least part of first CSI and/or second CSI to be reported.

In a third aspect, an embodiment of the present disclosure provides a communication apparatus, where the communication apparatus has some or all of the functions of the network device in the method described in the first aspect. For example, the functions of the communication apparatus may include some or all of the functions in the embodiments of the present disclosure, or may include the function of implementing any one of the embodiments of the present disclosure alone. The functions may be implemented by hardware or by hardware executing corresponding software. The hardware or software includes one or more units or modules corresponding to the above functions.

In an embodiment, the structure of the communication apparatus may include a transceiver module and a processing module, where the processing module is configured to support the communication apparatus to perform corresponding functions in the above method. The transceiver module is used to support communication between the communication apparatus and other devices. The communication apparatus may further include a storage module, where the storage module is coupled to the transceiver module and the processing module and stores necessary computer programs and data for the communication apparatus.

As an example, the processing module may be a processor, the transceiver module may be a transceiver or a communication interface, and the storage module may be a memory.

In a fourth aspect, an embodiment of the present disclosure provides another communication apparatus, where the communication apparatus has some or all of the functions of the terminal device in the method examples described in the second aspect. For example, the functions of the communication apparatus may include some or all of the functions in the embodiments of the present disclosure, or may include the function of implementing any one of the embodiments of the present disclosure alone. The functions may be implemented by hardware or by hardware executing corresponding software. The hardware or software includes one or more units or modules corresponding to the above functions.

In an embodiment, the structure of the communication apparatus may include a transceiver module and a processing module, where the processing module is configured to support the communication apparatus to perform corresponding functions in the above method. The transceiver module is used to support communication between the communication apparatus and other devices. The communication apparatus may further include a storage module, where the storage module is coupled to the transceiver module and the processing module and stores necessary computer programs and data for the communication apparatus.

In a fifth aspect, an embodiment of the present disclosure provides a communication apparatus, where the communication apparatus includes a processor, and when the processor invokes a computer program in a memory, the method described in the first aspect is executed.

In a sixth aspect, an embodiment of the present disclosure provides a communication apparatus, where the communication apparatus includes a processor, and when the processor invokes a computer program in a memory, the method described in the second aspect is executed.

In a seventh aspect, an embodiment of the present disclosure provides a communication apparatus, where the communication apparatus includes a processor and a memory, and the memory stores a computer program; the processor executes the computer program stored in the memory to cause the communication apparatus to perform the method described in the first aspect.

In an eighth aspect, an embodiment of the present disclosure provides a communication apparatus, where the communication apparatus includes a processor and a memory, and the memory stores a computer program; the processor executes the computer program stored in the memory to cause the communication apparatus to perform the method described in the second aspect.

In a ninth aspect, an embodiment of the present disclosure provides a communication apparatus, where the apparatus includes a processor and an interface circuit, and the interface circuit is used to receive code instructions and transmit them to the processor, and the processor is used to run the code instructions to cause the apparatus to perform the method described in the first aspect.

In a tenth aspect, an embodiment of the present disclosure provides a communication apparatus, where the apparatus includes a processor and an interface circuit, and the interface circuit is used to receive code instructions and transmit them to the processor, and the processor is used to run the code instructions to cause the apparatus to perform the method described in the second aspect.

In an eleventh aspect, an embodiment of the present disclosure provides a system for reporting CSI, where the system includes the communication apparatus according to the third aspect and the communication apparatus according to the fourth aspect; or the system includes the communication apparatus according to the fifth aspect and the communication apparatus according to the sixth aspect; or the system includes the communication apparatus according to the seventh aspect and the communication apparatus according to the eighth aspect; or the system includes the communication apparatus according to the ninth aspect and the communication apparatus according to the tenth aspect.

In a twelfth aspect, an embodiment of the present invention provides a computer-readable storage medium for storing instructions used by the above network device, where when the instructions are executed, the network device is caused to perform the method described in the first aspect.

In a thirteenth aspect, an embodiment of the present invention provides a readable storage medium for storing instructions used by the above terminal device, where when the instructions are executed, the terminal device is caused to perform the method described in the second aspect.

In a fourteenth aspect, the present disclosure further provides a computer program product including a computer program, where when run on a computer, the computer is caused to perform the method described in the first aspect.

In a fifteenth aspect, the present disclosure further provides a computer program product including a computer program, where when run on a computer, the computer is caused to perform the method described in the second aspect.

In a sixteenth aspect, the present disclosure provides a chip system, where the chip system includes at least one processor and an interface for supporting a network device to implement functions involved in the first aspect, for example, determining or processing at least one of data and information involved in the above method. In a possible design, the chip system further includes a memory, where the memory is used to store necessary computer programs and data for the network device. The chip system may be composed of chips or may include chips and other discrete devices.

In a seventeenth aspect, the present disclosure provides a chip system, where the chip system includes at least one processor and an interface for supporting a terminal device to implement functions involved in the second aspect, for example, determining or processing at least one of data and information involved in the above method. In a possible design, the chip system further includes a memory, where the memory is used to store necessary computer programs and data for the terminal device. The chip system may be composed of chips or may include chips and other discrete devices.

In an eighteenth aspect, the present disclosure provides a computer program, where when run on a computer, the computer is caused to perform the method described in the first aspect.

In a nineteenth aspect, the present disclosure provides a computer program, where when run on a computer, the computer is caused to perform the method described in the second aspect.

### BRIEF DESCRIPTION OF THE DRAWINGS

In order to more clearly illustrate the technical solutions in the embodiments of the present disclosure or the background art, the drawings used in the embodiments of the present disclosure or the background art will be described below.

FIG. 1 is a schematic structural diagram of a communication system in an embodiment of the present disclosure;

FIG. 2 is a schematic flowchart of a method for reporting CSI in an embodiment of the present disclosure;

FIG. 2a is a schematic diagram of reporting CSI obtained based on an AI method in an embodiment of the present disclosure;

FIG. 3 is a schematic flowchart of another method for reporting CSI in an embodiment of the present disclosure;

FIG. 4 is a schematic flowchart of another method for reporting CSI in an embodiment of the present disclosure;

FIG. 5 is a schematic flowchart of another method for reporting CSI in an embodiment of the present disclosure;

FIG. 6 is a schematic flowchart of another method for reporting CSI in an embodiment of the present disclosure;

FIG. 7 is a schematic flowchart of another method for reporting CSI in an embodiment of the present disclosure,

FIG. 8 is a schematic structural diagram of a communication apparatus in an embodiment of the present disclosure;

FIG. 9 is a schematic structural diagram of another communication apparatus in an embodiment of the present disclosure; and

FIG. 10 is a schematic structural diagram of a chip in an embodiment of the present disclosure.

### DETAILED DESCRIPTION

Exemplary embodiments will be described in detail here, with examples shown in the accompanying drawings. When the following description refers to the drawings, unless otherwise indicated, the same numbers in different drawings represent the same or similar elements. The implementations described in the following exemplary embodiments do not represent all implementations consistent with the present disclosure. Rather, they are merely examples of apparatuses and methods consistent with some aspects of the present disclosure as detailed in the appended claims.

The terms used in the embodiments of the present disclosure are for the purpose of describing specific embodiments only and are not intended to limit the embodiments of the present disclosure. The singular forms “a”, “an” and “the” used in the embodiments of the present disclosure and the appended claims are also intended to include plural forms, unless the context clearly indicates otherwise. It should also be understood that the term “and/or” as used herein refers to and includes any and all possible combinations of one or more associated listed items.

It should be understood that although terms such as first, second, third, etc. may be used in the embodiments of the present disclosure to describe various information, such information should not be limited by these terms. These terms are only used to distinguish information of the same type from each other. For example, without departing from the scope of the embodiments of the present disclosure, first information may also be referred to as second information, and similarly, second information may also be referred to as first information. Depending on the context, the word “if” as used herein may be interpreted as “when” or “upon” or “in response to determining”. For the sake of brevity and ease of understanding, the terms “greater than” or “less than”, “higher than” or “lower than” are used herein to characterize size relationships. However, those skilled in the art will understand that the term “greater than” also encompasses the meaning of “greater than or equal to”, and “less than” also encompasses the meaning of “less than or equal to”; the term “higher than” encompasses the meaning of “higher than or equal to”, and “lower than” also encompasses the meaning of “lower than or equal to”.

For ease of understanding, the terms involved in the present disclosure are first introduced.

A Channel State Information Reference Signal (CSI-RS) is a reference signal used to detect Channel State Information (CSI). A terminal device may perform channel state information detection to obtain a channel state information reference signal, and may send a Precoding Matrix Indicator (PMI) that best matches the channel conditions and its own demodulation performance to the network device based on the channel state information reference signal, for use by the network device in scheduling and downlink beamforming.

A Channel Quality Indicator (CQI) indicates the quality of the wireless channel and is used to adaptively select an appropriate modulation and coding scheme. The main process is: the CQI is measured by the terminal device from the CSI-RS and reported by the terminal device, and then the BS selects an appropriate modulation order, code rate, downlink data block size, etc, based on the CQI information to ensure that the UE obtains optimal downlink performance in different wireless environments.

A Rank Indicator (RI) indicates the number of supported spatial multiplexing data streams. To better understand a method for reporting CSI disclosed in the embodiments of the present disclosure, the communication system to which the embodiments of the present disclosure are applicable is first described.

Please refer to FIG. 1, which is a schematic structural diagram of a communication system in an embodiment of the present disclosure. The communication system may include, but is not limited to, one network device and one terminal device. The number and form of devices shown in FIG. 1 are for example only and do not constitute a limitation on the embodiments of the present disclosure. In practical applications, two or more network devices and two or more terminal devices may be included. The communication system shown in FIG. 1 includes one network device 101 and one terminal device 102 as an example.

It should be noted that the technical solutions of the embodiments of the present disclosure may be applied to various communication systems, for example: a third-generation (3G) Universal Mobile Telecommunications System (UMTS) Long Term Evolution (LTE) system, a fifth-generation (5G) mobile communication system, a 5G New Radio (NR) system, a sixth-generation (6G) mobile communication system, or other future new mobile communication systems.

The network device 101 in the embodiments of the present disclosure is an entity on the network side for transmitting or receiving signals. For example, the network device 101 may be an evolved NodeB (eNB), a transmission reception point (TRP), a next generation NodeB (gNB) in an NR system, a base station in other future mobile communication systems, or an access node in a wireless fidelity (WiFI) system. The specific technology and specific device form adopted by the network device are not limited in the embodiments of the present disclosure. The network device provided by the embodiments of the present disclosure may be composed of a central unit (CU) and a distributed unit (DU), where the CU may also be called a control unit. The structure of CU-DU may split the protocol layers of a network device, such as a base station, where the functions of some protocol layers are placed in the CU for centralized control, and the functions of the remaining part or all of the protocol layers are distributed in the DUs and are centrally controlled by the CU.

The terminal device 102 in the embodiments of the present disclosure is an entity on the user side for receiving or transmitting signals, such as a mobile phone. The terminal device may also be called a terminal, User Equipment (UE), a mobile station (MS), a mobile terminal (MT), etc. The terminal device may be a car with communication functions, a smart car, a mobile phone, a wearable device, an Internet of Things terminal (such as an NB-IoT, eMTC, etc. terminal), a tablet (Pad), a computer with wireless transceiver functions, a virtual reality (VR) terminal device, an augmented reality (AR) terminal device, a wireless terminal device in industrial control, a wireless terminal device in self-driving, a wireless terminal device in remote medical surgery, a wireless terminal device in a smart grid, a wireless terminal device in transportation safety, a wireless terminal device in a smart city, a wireless terminal device in a smart home, etc. The specific technology and specific device form adopted by the terminal device are not limited in the embodiments of the present disclosure.

It can be understood that the communication system described in the embodiments of the present disclosure is to more clearly illustrate the technical solutions of the embodiments of the present disclosure and does not constitute a limitation on the technical solutions provided by the embodiments of the present disclosure, Those of ordinary skill in the art will know that as the system architecture evolves and new service scenarios emerge, the technical solutions provided by the embodiments of the present disclosure are equally applicable to similar technical problems.

It should be noted that the method for reporting CSI provided by any embodiment of the present disclosure may be performed alone, or in combination with possible implementation methods in other embodiments, or in combination with any technical solution in the related art.

The method for reporting CSI and the apparatus therefor provided by the present disclosure are described in detail below with reference to the drawings.

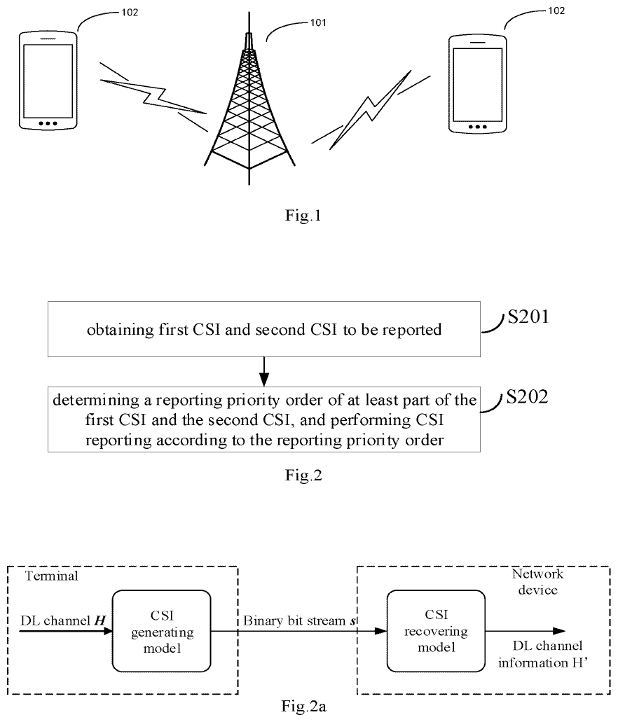

Please refer to FIG. 2, which is a schematic flowchart of a method for reporting CSI in an embodiment of the present disclosure. The method for reporting CSI may be performed by a terminal device. As shown in FIG. 2, the method may include, but is not limited to, the following steps:

S201: obtaining first CSI and second CSI to be reported.

In some embodiments, the first CSI includes at least one of the following information: a first measurement parameter for beam management, first CSI-related information, or L1 measurement parameters of all beams. The second CSI includes at least one of the following information: a second measurement parameter for beam management, second CSI-related information, or input information of an Artificial Intelligence (AI)/Machine Learning (ML) model.

In the embodiments of the present disclosure, the first CSI to be reported is obtained based on traditional methods, and the second CSI to be reported is obtained based on AI methods.

In some embodiments, obtaining the first CSI to be reported based on traditional methods includes: the terminal device receives Channel State Information-Reference Signals (CSI-RS) of multiple beams sent by the network device, and the terminal device performs channel estimation based on the CSI-RS to obtain the first CSI to be reported.

In some embodiments, the first CSI obtained based on traditional methods includes at least one of the following information:
a first measurement parameter for beam management obtained based on traditional methods;
first CSI-related information obtained based on traditional methods;
L1 measurement parameters of all beams obtained based on traditional methods.

Optionally, the first measurement parameter for beam management obtained based on traditional methods is one or more measurement parameters among the L1 measurement parameters of all beams obtained based on traditional methods. Optionally, the first measurement parameter may be a measurement parameter among the L1 measurement parameters that represents better signal quality. The first measurement parameter may include L1-measured Reference Signal Receiving Power (L1-RSRP) and/or L1-measured Signal to Interference plus Noise Ratio (L1-SINR).

Optionally, the first CSI-related information obtained based on traditional methods may include one or more of: Channel Quality Indication (CQI), Rank Indication (RI), or Precoding Matrix Indication (PMI). The RI is used to indicate the current number of data layers for transmission, and the PMI is used to indicate the transmission beam to be used when transmitting data.

Optionally, the L1 measurement parameters of all beams obtained based on traditional methods may include: L1-RSRP and/or L1-SINR corresponding to each CSI-RS.

In some embodiments, Artificial Intelligence (AI)/Machine Learning (ML) may be used to obtain CSI, which can achieve the purpose of reducing feedback overhead of the terminal device and improving CSI feedback accuracy. As shown in FIG. 2a, it is a schematic diagram of CSI compression feedback and recovery based on a bilateral AI/ML model. A CSI generation model is trained on the terminal device side in advance based on training samples to obtain a trained CSI generation model. A CSI recovery model is trained on the network device in advance based on training samples to obtain a trained CSI recovery model. The terminal device may compress downlink channel information H based on the trained CSI generation model to obtain the second CSI to be reported, which is quantized into a binary bit stream and sent to the network device. Further, the network device may recover the compressed second CSI through the CSI recovery model to obtain H′ that approximates the original downlink channel information.

In some embodiments, the second CSI obtained based on AI methods includes at least one of the following information:
a second measurement parameter for beam management obtained based on AI methods;
second CSI-related information obtained based on AI methods;
input information of an AI/ML model when obtaining CSI based on AI methods.

Optionally, the second measurement parameter for beam management obtained based on AI methods is one or more measurement parameters among the L1 measurement parameters of all beams obtained based on traditional methods. Optionally, the second measurement parameter may be a measurement parameter among the L1 measurement parameters that represents better signal quality. The second measurement parameter may include L1-RSRP and/or L1-SINR. It can be understood that the second measurement parameter for beam management obtained based on AI methods is a result obtained through reasoning by the CSI generation model of the terminal device.

Optionally, the second CSI-related information obtained based on AI methods may include, but is not limited to, one or more of: CQI, RI, or CSI compression information.

Optionally, the input information of the AI/ML model when obtaining CSI based on AI methods. Optionally, the input information may include, but is not limited to, downlink channel information H.

In some embodiments, when the network device needs to detect the performance of the CSI recovery model, the terminal device may report the input information of the AI/ML model to the network device.

S202: determining a reporting priority order of at least part of the first CSI and the second CSI, and performing CSI reporting according to the reporting priority order.

In some embodiments, the reporting priority order between the first CSI and the second CSI may be determined. For example, it may be determined that the reporting priority of the first CSI is higher than that of the second CSI. As another example, it may be determined that the reporting priority of the second CSI is higher than that of the first CSI.

In some embodiments, the reporting priority of each type of CSI in the first CSI may be determined. For example, the reporting priority of the first measurement parameter for beam management obtained based on traditional methods is higher than that of the first CSI-related information obtained based on traditional methods. As another example, the reporting priority of the first measurement parameter for beam management obtained based on traditional methods is higher than that of all L1 measurement parameters obtained based on traditional methods.

In some embodiments, the reporting priority of each type of CSI in the second CSI may be determined. For example, the reporting priority of the second measurement parameter for beam management obtained based on AI methods is higher than that of the second CSI-related information obtained based on AI methods. As another example, the reporting priority of the second measurement parameter for beam management obtained based on AI methods is higher than that of the input information of the AI/ML model when obtaining CSI based on AI methods.

After obtaining the reporting priority of each type of CSI in the first CSI and the reporting priority of each type of CSI in the second CSI, priority ordering may be performed on all types of CSI to obtain the reporting priority order of at least part of the first CSI and the second CSI.

In some embodiments, reporting priority ordering may be performed on part of the CSI in the first CSI and each type of CSI in the second CSI. In some embodiments, reporting priority ordering may be performed on each type of CSI in the first CSI and part of the CSI in the second CSI. In some embodiments, reporting priority ordering may be performed on part of the CSI in the first CSI and part of the CSI in the second CSI.

In some embodiments, reporting priority ordering may be performed on the same type of CSI in the first CSI and the second CSI, Optionally, CSI of a specified type from the first CSI and CSI of the specified type from the second CSI are selected, and priority ordering is performed on the CSI of the specified type. For example, the specified type may be CSI for beam management.

In some embodiments, reporting priority ordering may be performed on different types of CSI in the first CSI and the second CSI. For example, it may be determined that the reporting priority of CSI for beam management is higher than that of the obtained CSI-related information.

In the embodiments of the present disclosure, after obtaining the first CSI and the second CSI, the reporting priority order of at least part of the first CSI and the second CSI may be determined. After obtaining this priority order, the first CSI and/or the second CSI may be reported according to this priority order.

In some embodiments, when there is a reporting conflict between the first CSI and the second CSI, CSI to be discarded may be determined from the first CSI and the second CSI based on the priority order, and the remaining CSI may be reported according to the reporting priority.

In some embodiments, when the number of CSI allowed to be reported is less than the number of CSI to be reported, CSI to be discarded may be determined from the first CSI and the second CSI based on the priority order, and the remaining CSI may be reported according to the reporting priority. Optionally, the terminal device may report the remaining CSI to the network device based on uplink transmission sources configured by the network device.

In the embodiments of the present disclosure, the first CSI to be reported is obtained based on traditional methods, and the second CSI to be reported is obtained based on AI methods, the reporting priority order of the first CSI and the second CSI is determined, and CSI reporting is performed according to the priority order. In the embodiments of the present disclosure, during the process where the terminal device reports CSI to the network device, if there is a reporting conflict between the CSI obtained based on AI methods and the CSI obtained through traditional methods, the reporting priority order of the first CSI and the second CSI determined can solve the above reporting conflict problem, achieve the purpose of reasonably reporting CSI, and reduce the impact on system performance.

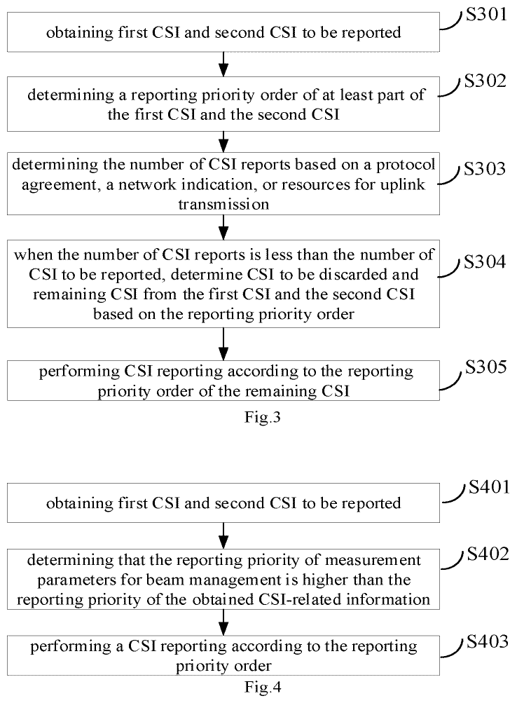

Please refer to FIG. 3, which is a schematic flowchart of another method for reporting CSI in an embodiment of the present disclosure. The method for reporting CSI may be performed by a terminal device. As shown in FIG. 3, the method may include, but is not limited to, the following steps:

S301: obtaining first CSI and second CSI to be reported.

In the embodiments of the present disclosure, the first CSI to be reported is obtained based on traditional methods, and the second CSI to be reported is obtained based on AI methods.

In some embodiments, the first CSI includes at least one of the following information:
a first measurement parameter for beam management obtained based on traditional methods;
first CSI-related information obtained based on traditional methods;
L1 measurement parameters of all beams obtained based on traditional methods.

In some embodiments, the second CSI obtained based on AI methods includes at least one of the following information;
a second measurement parameter for beam management obtained based on AI methods;
second CSI-related information obtained based on AI methods;
input information of an AI/ML model when obtaining CSI based on AI methods.

In the embodiments of the present disclosure, the implementation of step S301 may be implemented in any manner in the various embodiments of the present disclosure, which is not limited herein and will not be repeated.

S302: determining a reporting priority order of at least part of the first CSI and the second CSI

In the embodiments of the present disclosure, the implementation of step S302 may be implemented in any manner in the various embodiments of the present disclosure, which is not limited herein and will not be repeated.

S303: determining the number of CSI reports based on a protocol agreement, a network indication, or resources for uplink transmission.

In some embodiments, the terminal device may determine the number of CSI allowed to be reported and the number of CSI to be reported. Further, based on the number of CSI reports and the number of CSI to be reported, it is determined whether there is an upload conflict between the first CSI and the second CSI. If the number of CSI reports is less than the number of CSI to be reported, it indicates that there is an upload conflict between the first CSI and the second CSI, and then part of the CSI needs to be reasonably discarded according to the reporting priority order.

In some embodiments, the number of CSI allowed to be reported by the terminal device may be determined based on a protocol agreement.

In some embodiments, the number of CSI allowed to be reported by the terminal device may be determined based on a network indication. Optionally, the terminal device may receive indication information sent by the network device and determine the number of CSI reports based on the indication information. For example, the terminal device may receive indication information sent by the network device through Radio Resource Control (RRC) signaling. As another example, the terminal device may receive indication information sent by the network device through Downlink Control Information (DCI) signaling. As another example, the terminal device may receive indication information sent by the network device through Media Access Control Control Element (MAC CE) signaling.

In some embodiments, the number of CSI allowed to be reported by the terminal device may be determined based on uplink transmission resources. It can be understood that the number of CSI reports is less than or equal to the number of uplink transmission resources. Optionally, the terminal device may receive resource indication information from the network device and determine uplink transmission resources and/or the number of uplink transmission resources based on the resource indication information. Optionally, the resource indication information may be transmitted through RRC signaling, DCI signaling, or MAC CE signaling.

S304: when the number of CSI reports is less than the number of CSI to be reported, determine CSI to be discarded and remaining CSI from the first CSI and the second CSI based on the reporting priority order.

Optionally, the CSI to be discarded determined from the first CSI and the second CSI may be one or more types of CSI in the first CSI. Optionally, the CSI to be discarded determined from the first CSI and the second CSI may be one or more types of CSI in the second CSI. Optionally, the CSI to be discarded determined from the first CSI and the second CSI may include one or more types of CSI in the first CSI and one or more types of CSI in the second CSI.

Optionally, the remaining CSI may be one or more types of CSI in the first CSI. Optionally, the remaining CSI may be one or more types of CSI in the second CSI. Optionally, the remaining CSI may include one or more types of CSI in the first CSI and one or more types of CSI in the second CSI.

S305: performing CSI reporting according to the reporting priority order of the remaining CSI.

The terminal device may report the remaining CSI to the network device based on uplink transmission resources configured by the network device and according to the reporting priority of the remaining CSI.

For illustrative purposes, the number of CSI reports is 3, and the number of CSI to be reported is 4, including a first measurement parameter for beam management obtained based on traditional methods, a second measurement parameter for beam management obtained based on AI methods, first CSI-related information obtained based on traditional methods, and second CSI-related information obtained based on AI methods. If the reporting priority order is that the reporting priority of the second measurement parameter for beam management is higher than that of the first measurement parameter for beam management, the reporting priority of the first measurement parameter is higher than that of the second CSI-related information, and the reporting priority of the second CSI-related information is higher than that of the first CSI-related information.

Further, according to this reporting priority order, the first CSI-related information is determined as the CSI to be discarded, and the second measurement parameter, the first measurement parameter, and the second CSI-related information are determined as the remaining CSI. After determining the remaining CSI, the terminal device may report the second measurement parameter, the first measurement parameter, and the second CSI-related information to the network device based on uplink transmission resources configured by the network device and according to the reporting priority of the remaining CSI. That is, the determined remaining CSI is the CSI reported by the terminal device to the network device.

In the embodiments of the present disclosure, during the process where the terminal device reports CSI to the network device, if there is a reporting conflict between the CSI obtained based on AI methods and the CSI obtained through traditional methods, part of the CSI may be determined to be discarded from the first CSI and/or the second CSI according to the reporting priority order of the first CSI and the second CSI, so as to solve the above reporting conflict problem, achieve the purpose of reasonably reporting CSI, and reduce the impact on system performance.

Please refer to FIG. 4, which is a schematic flowchart of another method for reporting CSI in an embodiment of the present disclosure. The method for reporting CSI may be performed by a terminal device. As shown in FIG. 4, the method may include, but is not limited to, the following steps:

S401: obtaining first CSI and second CSI to be reported.

In the embodiments of the present disclosure, the first CSI to be reported is obtained based on traditional methods, and the second CSI to be reported is obtained based on AI methods.
where the first CSI includes at least one of the following information;
a first measurement parameter for beam management obtained based on traditional methods;
first CSI-related information obtained based on traditional methods;
L1 measurement parameters of all beams obtained based on traditional methods.

In some embodiments, the second CSI obtained based on AI methods includes at least one of the following information:
a second measurement parameter for beam management obtained based on AI methods;
second CSI-related information obtained based on AI methods;
input information of an AI model when obtaining CSI based on AI methods.

In the embodiments of the present disclosure, the implementation of step S401 may be implemented in any manner in the various embodiments of the present disclosure, which is not limited herein and will not be repeated.

S402: determining that the reporting priority of measurement parameters for beam management is higher than the reporting priority of the obtained CSI-related information.

In some embodiments, the measurement parameter for beam management obtained based on traditional methods is determined from the first CSI, and the measurement parameter for beam management obtained based on AI methods is determined from the second CSI. Optionally, the measurement parameters for beam management determined from the first CSI and the second CSI may include one or more of: the first measurement parameter for beam management, the second measurement parameter for beam management, or L1 measurement parameters of all beams.

In some embodiments, the CSI-related information obtained based on traditional methods is determined from the first CSI, and the CSI-related information obtained based on AI methods is determined from the second CSI Optionally, the CSI-related information determined from the first CSI and the second CSI may include one or more of: the first CSI-related information, the second CSI-related information, or the input information of the AL/ML model.

In some embodiments, it is determined that the reporting priority of measurement parameters for beam management is higher than the reporting priority of the obtained CSI-related information. Optionally, it is determined that the reporting priority of at least part of the measurement parameters for beam management is higher than the reporting priority of part of the CSI-related information. Optionally, it may be determined that the reporting priority of the first measurement parameter and the second measurement parameter for beam management is higher than the reporting priority of the first CSI-related information and the second CSI-related information. Optionally, it may be determined that the reporting priority of the first measurement parameter, the second measurement parameter, and the L1 measurement parameters of all beams for beam management is higher than the reporting priority of the first CSI-related information, the second CSI-related information, and the input information of the AL/ML model.

Optionally, the reporting priority of at least part of the information among the first measurement parameter, the second measurement parameter, and the L1 measurement parameters of all beams, and the reporting priority of at least part of the information among the first CSI-related information, the second CSI-related information, and the input information of the AL/ML model may be determined based on a protocol agreement or set rules. The reporting priority of measurement parameters for beam management is higher than the reporting priority of the obtained CSI-related information.

Optionally, the reporting priority of at least part of the information among the first measurement parameter, the second measurement parameter, and the L1 measurement parameters of all beans, and the reporting priority of at least part of the information among the first CSI-related information, the second CSI-related information, and the input information of the AI/ML model may be determined based on a priority determination formula. The reporting priority of measurement parameters for beam management is higher than the reporting priority of the obtained CSI-related information.

S404: performing a CSI reporting according to the reporting priority order.

In the embodiments of the present disclosure, after obtaining the reporting priority order of the first CSI and the second CSI, the first CSI and/or the second CSI may be reported according to this priority order. In some embodiments, when there is a reporting conflict between the first CSI and the second CSI, CSI to be discarded may be determined from the first CSI and the second CSI based on the priority order, and the remaining CSI may be reported according to the reporting priority.

In some embodiments, when the number of CSI allowed to be reported is less than the number of CSI to be reported, CSI to be discarded may be determined from the first CSI and the second CSI based on the priority order, and the remaining CSI may be reported according to the reporting priority. Optionally, the terminal device may report the remaining CSI to the network device based on uplink transmission resources configured by the network device and according to the reporting priority of the remaining CSI.

For illustrative purposes, the number of CSI reports is 3, and the number of CSI to be reported is 4, including a first measurement parameter for beam management obtained based on traditional methods, a second measurement parameter for beam management obtained based on AI methods, first CSI-related information obtained based on traditional methods, and second CSI-related information obtained based on AI methods. In this example, the reporting priority of the first measurement parameter and the second measurement parameter for beam management is higher than the reporting priority of the first CSI-related information and the second CSI-related information. Further, the reporting priority order between the first CSI-related information and the second CSI-related information is determined. If the reporting priority of the first CSI-related information is higher than that of the second CSI-related information, in the embodiments of the present disclosure, the reporting priority order of the first CSI and the second CSI is: the reporting priority of the first measurement parameter and the second measurement parameter for beam management is higher than that of the first CSI-related information; the reporting priority of the first CSI-related information is higher than that of the second CSI-related information.

Further, according to this reporting priority order, the second CSI-related information is determined as the CSI to be discarded, and the first measurement parameter, the second measurement parameter, and the first CSI-related information are taken as the remaining CSI. After determining the remaining CSI, the terminal device may report the first measurement parameter, the second measurement parameter, and the first CSI-related information to the network device based on uplink transmission resources configured by the network device and according to the reporting priority of the remaining CSI. That is, the determined remaining CSI is the CSI reported by the terminal device to the network device.

In the embodiments of the present disclosure, during the process where the terminal device reports CSI to the network device, if there is a reporting conflict between the CSI obtained based on AI methods and the CSI obtained through traditional methods, part of the CSI may be determined to be discarded from the first CSI and/or the second CSI according to the reporting priority order of the first CSI and the second CSI, so as to solve the above reporting conflict problem, achieve the purpose of reasonably reporting CSI, and reduce the impact on system performance.

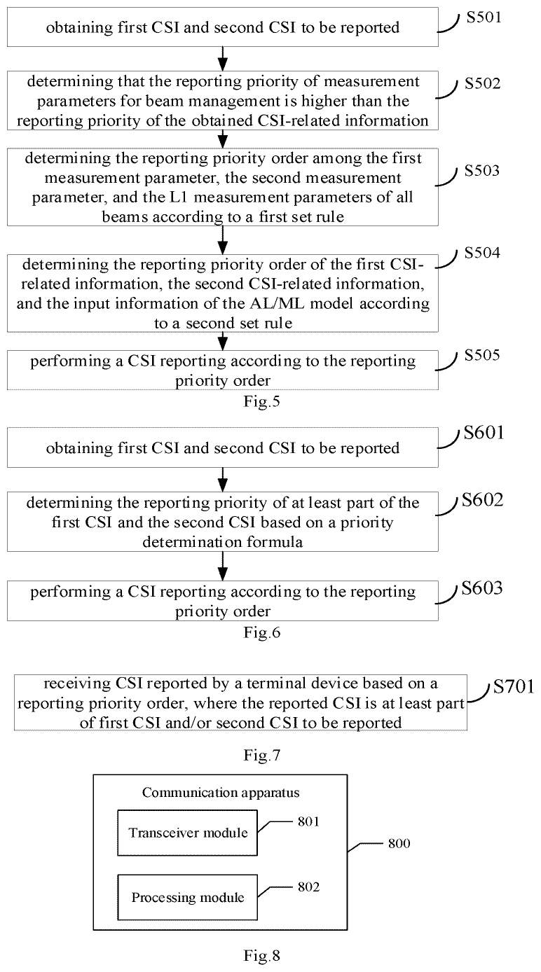

Please refer to FIG. 5, which is a schematic flowchart of another method for reporting CSI in an embodiment of the present disclosure. The method for reporting CSI may be performed by a terminal device. As shown in FIG. 5, the method may include, but is not limited to, the following steps:

S501: obtaining first CSI and second CSI to be reported.

In the embodiments of the present disclosure, the first CSI to be reported is obtained based on traditional methods, and the second CSI to be reported is obtained based on AI methods,
where the first CSI includes at least one of the following information:
a first measurement parameter for beam management obtained based on traditional methods;
first CSI-related information obtained based on traditional methods;
L1 measurement parameters of all beams obtained based on traditional methods.

In some embodiments, the second CSI obtained based on AI methods includes at least one of the following information:
a second measurement parameter for beam management obtained based on AI methods;
second CSI-related information obtained based on AI methods;
input information of an AI model when obtaining CSI based on AI methods.

In the embodiments of the present disclosure, the implementation of step S501 may be implemented in any manner in the various embodiments of the present disclosure, which is not limited herein and will not be repeated.

S502: determining that the reporting priority of measurement parameters for beam management is higher than the reporting priority of the obtained CSI-related information.

In the embodiments of the present disclosure, the implementation of step S503 may be implemented in any manner in the various embodiments of the present disclosure, which is not limited herein and will not be repeated.

S503: determining the reporting priority order among the first measurement parameter, the second measurement parameter, and the L1 measurement parameters of all beams according to a first set rule.

In the embodiments of the present disclosure, let Class A CSI represent the first measurement parameter for beam management obtained based on traditional methods. The first measurement parameter may include, but is not limited to, L1-RSRP or L1-SINR; Class B CSI represents the second measurement parameter for beam management obtained based on AI methods. The second measurement parameter may include, but is not limited to, L1-RSRP or a beam index; Class C CSI represents the L1 measurement parameters of all beams obtained based on traditional methods, where the L1 measurement parameters include, but are not limited to, L1-RSRP or L1-SINR; Class D CSI represents the first CSI-related information obtained based on traditional methods, where the first CSI-related information includes, but is not limited to, RI, CQI, or PMI; Class E CSI represents the second CSI-related information obtained based on AI methods, where the second CSI-related information includes, but is not limited to, RI, CQI, and CSI compression and quantization information obtained based on AI methods; Class F CSI represents the reporting of Input-CSI-NW when obtaining CSI based on AI.

In some embodiments, the reporting priority order of CSI related to beam management may be determined based on the first set rule. In the embodiments of the present disclosure, CSI related to beam management may include the first measurement parameter for beam management (Class A CSI), the second measurement parameter for beam management (Class B CSI), and the L1 measurement parameters of all beams obtained based on traditional methods (Class C CSI).

Optionally, the reporting priority order of CSI related to beam management may be: the reporting priority of Class C CSI is higher than that of Class B CSI, and the reporting priority of Class B CSI is higher than that of Class A CSI; or, the reporting priority of Class C CSI is higher than that of Class A CSL and the reporting priority of Class A CSI is higher than that of Class B CSI; that is, Class C CSI>Class B CSI>Class A CSI, or Class C CSI>Class A CSI>Class B CSI.

Optionally, the reporting priority order of CSI related to beam management may be: the reporting priority of Class B CSI is higher than that of Class A CSI, and the reporting priority of Class A CSI is higher than that of Class C CSI, or, the reporting priority of Class B CSI is higher than that of Class C CSI, and the reporting priority of Class C CSI is higher than that of Class A CSI; that is, Class B CSI>Class A CSI>Class C CSI, or Class B CSI>Class C CSI>Class A CSL

Optionally, the reporting priority order of CSI related to beam management may be: the reporting priority of Class A CSI is higher than that of Class B CSI, and the reporting priority of Class B CSI is higher than that of Class C CSI; or, the reporting priority of Class A CSI is higher than that of Class C CSI, and the reporting priority of Class C CSI is higher than that of Class B CSI; that is, Class A CSI>Class B CSI>Class C CSI, or Class A CSI>Class C CSI>Class B CSI.

It can be understood that the reporting priority order of CSI related to beam management may be one of the following orders: Class C CSI>Class B CSI>Class A CSI, or Class C CSI>Class A CSI>Class B CSI, or Class B CSI>Class A CSI>Class C CSI, or Class B CSI>Class C CSI>Class A CSI, or Class A CSI>Class B CSI>Class C CSI, or Class A CSI>Class C CSI>Class B CSI.

Optionally, the reporting priority order adopted for CSI related to beam management may be determined through a protocol agreement or network indication. For example, it may be agreed by protocol or indicated by the network to adopt Class C. CSI>Class A CSI>Class B CSL

S504: determining the reporting priority order of the first CSI-related information, the second CSI-related information, and the input information of the AL/ML model according to a second set rule.

In some embodiments, the reporting priority order of CSI related to CSI acquisition may be determined based on the second set rule. In the embodiments of the present disclosure, CSI related to CSI acquisition may include the first CSI-related information (Class D CSI), the second CSI-related information (Class E CSI), and the input information of the AL/ML model (Class F CSI).

Optionally, the reporting priority order of CSI related to CSI acquisition may be: the reporting priority of Class F CSI is higher than that of Class E CSI, and the reporting priority of Class E CSI is higher than that of Class D CSI: or, the reporting priority of Class F CSI is higher than that of Class D CSI, and the reporting priority of Class D CSI is higher than that of Class B CSI; that is, Class F CSI>Class B CSI>>Class D CSI, or Class F CSI>Class D CSI>Class E CSL

Optionally, the reporting priority order of CSI related to CSI acquisition may be: the reporting priority of Class B CSI is higher than that of Class D CSI, and the reporting priority of Class D CSI is higher than that of Class F CSI; or, the reporting priority of Class E CSE is higher than that of Class F CSI, and the reporting priority of Class F CSI is higher than that of Class D CSI; that is, Class E CSI>Class D CSI>Class F CSI, or Class B CSI>Class F CSI>Class D CSL

Optionally, the reporting priority order of CSI related to CSI acquisition may be: the reporting priority of Class D CSI is higher than that of Class F CSI, and the reporting priority of Class F CSI is higher than that of Class E CSI; or, the reporting priority of Class D CSI is higher than that of Class B CSI, and the reporting priority of Class E CSI is higher than that of Class F CSI; that is, Class D CSI>Class F CSI>Class E CSI, or Class D CSI>Class E CSI>Class F CSI.

It can be understood that the reporting priority order of CSI related to CSI acquisition may be one of the following orders: Class F CSI>Class E CSI>Class D CSI, or Class F CSI>Class D CSI>Class E CSI, or Class E CSI>Class D CSI>Class F CSI, or Class E CSI>Class F CSI>Class D CSI, or Class D CSI>Class F CSI>Class E CSI, or Class D CSI>Class E CSI>Class F CSL

Optionally, the reporting priority order adopted for CSI related to CSI acquisition may be determined through a protocol agreement or network indication. For example, it may be agreed by protocol or indicated by the network to adopt Class F CSI>Class D CSI>Class E CSL

S505: performing a CSI reporting according to the reporting priority order.

In the embodiments of the present disclosure, after obtaining the reporting priority order of the first CSI and the second CSI, the first CSI and/or the second CSI may be reported according to this priority order. In some embodiments, when there is a reporting conflict between the first CSI and the second CSI, CSI to be discarded may be determined from the first CSI and the second CSI based on the priority order, and the remaining CSI may be reported according to the reporting priority.

In some embodiments, when the number of CSI allowed to be reported is less than the number of CSI to be reported, CSI to be discarded may be determined from the first CSI and the second CSI based on the priority order, and the remaining CSI may be reported according to the reporting priority, Optionally, the terminal device may report the remaining CSI to the network device based on uplink transmission resources configured by the network device and according to the reporting priority of the remaining CSI.

For illustrative purposes, the number of CSI reports is 3, and the number of CSI to be reported is 4. In the embodiments of the present disclosure, the reporting priority of CSI related to beam management is higher than that of CSI related to CSI acquisition; that is, the reporting priority of Class A CSI, Class B CSI, and Class C CSI is higher than that of Class D CSI, Class E CSI, and Class F CSI.

If it is agreed by protocol or indicated by the network that the reporting priority order of Class A CSI, Class B CSI, and Class C CSI is: Class C CSI>Class B CSI>Class A CSI; and the reporting priority order of Class D CSI, Class E CSI, and Class F CSI is: Class D CSI>Class F CSI>Class B CSI.

In this example, the number of CSI to be reported is 4, including Class A CSI, Class C CSI, Class D CSI, and Class E CSI. Since the number of CSI reports is 3 and the number of CSI to be reported is 4, it indicates that there is a reporting conflict between the first CSI and the second CSI. Based on the above priority agreement, Class E CSI may be determined as the CSI to be discarded, and Class A CSI, Class C CSI, and Class D CSI are determined as the remaining CSI to be reported.

Further, after determining the remaining CSI, the terminal device may report Class A CSI, Class C CSI, and Class D CSI to the network device based on uplink transmission resources configured by the network device and according to the reporting priority of the remaining CSI.

In the embodiments of the present disclosure, during the process where the terminal device reports CSI to the network device, if there is a reporting conflict between the CSI obtained based on AI methods and the CSI obtained through traditional methods, part of the CSI may be determined to be discarded from the first CSI and/or the second CSI according to the reporting priority order of the first CSI and the second CSI, so as to solve the above reporting conflict problem, achieve the purpose of reasonably reporting CSI, and reduce the impact on system performance.

Please refer to FIG. 6, which is a schematic flowchart of another method for reporting CSI in an embodiment of the present disclosure. The method for reporting CSI may be performed by a terminal device. As shown in FIG. 6, the method may include, but is not limited to, the following steps:

S601: obtaining first CSI and second CSI to be reported.

In the embodiments of the present disclosure, the first CSI to be reported is obtained based on traditional methods, and the second CSI to be reported is obtained based on AI methods.
where the first CSI includes at least one of the following information:
a first measurement parameter for beam management obtained based on traditional methods;
first CSI-related information obtained based on traditional methods;
L1 measurement parameters of all beams obtained based on traditional methods.

In some embodiments, the second CSI obtained based on AI methods includes at least one of the following information:
a second measurement parameter for beam management obtained based on AI methods;
second CSI-related information obtained based on AI methods;
input information of an AI model when obtaining CSI based on AI methods.

In the embodiments of the present disclosure, the implementation of step S601 may be implemented in any manner in the various embodiments of the present disclosure, which is not limited herein and will not be repeated.

S602: determining the reporting priority of at least part of the first CSI and the second CSI based on a priority determination formula.

In some embodiments, the priority determination formula is a preconfigured or pre-agreed first priority determination formula. Optionally, the priority of at least part of the first CSI and the second CSI is determined based on the first priority determination formula. That is, the priority of at least part of the first CSI may be determined based on the first priority determination formula, and/or the priority of at least part of the second CSI may be determined based on the first priority determination formula.

In some embodiments, the first CSI and the second CSI reuse the original parameters in the first priority determination formula.

Optionally, the time-domain characteristics of CSI may include, but are not limited to: aperiodic CSI reporting, semi-persistent CSI reporting, and periodic CSI reporting.

Optionally, the bearer channels of CSI may include, but are not limited to: PUSCH and PUCCH.

Optionally, the combination of time-domain characteristics and bearer channels may include, but is not limited to: aperiodic CSI reporting borne on PUSCH, semi-persistent CSI reporting borne on PUSCH, semi-persistent CSI reporting borne on PUCCH, periodic CSI reporting borne on PUCCH, and other combinations.

The priority determination formula is a predefined first priority determination formula, which is shown in the following formula (1):

$${Pri}_{iCSI} ( y , k , c , s ) = 2 \cdot {N}_{cells} \cdot {M}_{s} \cdot y + {N}_{cells} \cdot {M}_{s} \cdot k + {M}_{s} \cdot c + s$$

where's is the reporting Identity (ID) of CSI; c is the serving cell index;
the first priority determination formula includes a first original parameter y and a second original parameter k;
the value of the first original parameter y is used to indicate different combinations of time-domain characteristics and bearer channels during CSI reporting; y=0) indicates aperiodic CSI reporting borne on PUSCH; y=1 indicates semi-persistent CSI reporting borne on PUSCH; y=2 indicates semi-persistent CSI reporting borne on PUCCH; y=3 indicates periodic CSI reporting borne on PUCCH;
the value of the second original parameter k is used to indicate the type of information reported in CSI; k=0 indicates L1-RSRP or L1-SINR reporting, k=1 indicates other CSI reporting except L1-RSRP or L1-SINR;

Mₛ represents the maximum number of CSI reports configured by the network; N_{cells} represents the maximum number of serving cells configured by the network.

It should be noted that the smaller the value of Pri_{iCSI}(y,k,c,s), the higher the reporting priority of the CSI.

In the embodiments of the present disclosure, the reporting priority of the first CSI is determined based on the predefined value of the original parameter corresponding to the first CSI. That is, for the first CSI obtained based on traditional methods, the value of the original parameter remains unchanged. The reporting priority of at least part of the first CSI is determined based on the first priority determination formula and the predefined value of the original parameter corresponding to the first CSI. Further, the predefined value or a new value of the original parameter corresponding to the second CSI is determined, and the reporting priority of at least part of the second CSI is determined based on the predefined value or new value of the original parameter corresponding to the second CSI.

In some embodiments, the predefined value or a new value of the first original parameter y corresponding to the second CSI may be determined.

Optionally, the predefined value of the first original parameter y corresponding to the second CSI is determined, where the predefined value of the first original parameter y corresponding to the second CSI is a value in the predefined first candidate value set of the first original parameter y, for example, y={0,1,2,3}. That is, the second CSI may reuse the predefined value of the first original parameter y corresponding to the first CSI reporting. For example, the predefined value of the first original parameter y corresponding to the second CSI may be the maximum value or the minimum value among all predefined values of the first original parameter y. For example, the predefined first candidate value set is: y={0,1,2,3}, the predefined value of the first original parameter y corresponding to the second CSI may be 0, or the predefined value of the first original parameter y corresponding to the second CSI may be 3.

Optionally, the new value of the first original parameter y corresponding to the second CSI is a value outside the first candidate value set. That is, a new value of the first original parameter y is defined for the second CSI to determine the reporting priority of the second CSI. For example, define y=4 to indicate periodic CSI reporting obtained based on AI methods and borne on PUCCH. As another example, y=0 may be redefined to indicate periodic CSI reporting obtained based on AI methods and borne on PUCCH.

Optionally, the value of the second original parameter k corresponding to the second CSI is determined. The predefined value of the second original parameter k corresponding to the second CSI is a value in the predefined second candidate value set of the second original parameter k. That is, the second CSI may reuse the predefined value of the second original parameter k corresponding to the first CSI reporting. For example, the value of the second original parameter k corresponding to the second CSI may be the maximum value or the minimum value among all predefined values of the second original parameter k. For example, the predefined second candidate value set is: k={0,1}, the value of the second original parameter k corresponding to the second CSI may be 0, or the value of the second original parameter k corresponding to the second CSI may be 1.

Optionally, the new value of the second original parameter k corresponding to the second CSI is a value outside the second candidate value set. That is, a new value of the second original parameter k is defined for the second CSI to determine the reporting priority of the second CSI. For example, define k=3 to indicate CSI reporting obtained based on AI methods.

For illustrative purposes, if the CSI to be reported includes RI/CQI/CSI compression information based on AI, a beam index obtained based on AI methods, and a first measurement parameter for beam management obtained based on traditional methods (L1-RSRP), that is, three CSI reports to be reported, Mₛ=3. The CSI reporting IDs of these three are configured by the gNB as s=3, s=1, and s=2, respectively. The second CSI obtained based on AI methods, such as RI/CQI/CSI compression information, may be reported to the network device through aperiodic CSI borne on PUSCH. Define k=0 for the beam index reporting obtained based on AI methods, k=1 for the CSI reporting for beam management obtained based on traditional methods, and y=0 for the reporting of the second CSI-related information (RI/CQI/CSI compression information) obtained based on AI methods; there is one serving cell, that is, N_{cells}=1, and they are reported within the same serving cell, and the index of the serving cell is 1.

Based on the first priority determination formula (1), the reporting priority of the beam index obtained based on AI methods can be determined as: Pri_{iCSI}(y,k,c,s)=4; based on the first priority determination formula (1), the reporting priority of the first measurement parameter for beam management obtained based on traditional methods can be determined as: Pri_{iCSI}(y,k,c,s)=5; based on the first priority determination formula (1), the reporting priority of the second CSI-related information obtained based on AI methods can be determined as: Pri_{iCSI}(y,k,c,s)=6.

In this example, the reporting priority order of the CSI to be reported is: the reporting priority of the beam index obtained based on AI methods is higher than that of the first measurement parameter for beam management; the reporting priority of the first measurement parameter for beam management is higher than that of the second CSI-related information.

In some embodiments, the priority determination formula is a second priority determination formula, which includes the original parameters in the first priority determination formula and new parameters added for the second CSI. Optionally, the priority of at least part of the first CSI and the second CSI is determined based on the second priority determination formula. That is, the priority of at least part of the first CSI may be determined based on the second priority determination formula, and/or the priority of at least part of the second CSI may be determined based on the second priority determination formula.

In some embodiments, the value of the original parameter corresponding to the first CSI is determined, and the reporting priority of at least part of the first CSI is determined based on the value of the original parameter corresponding to the first CSI; the value of the new parameter corresponding to the second CSI is determined, and the reporting priority of at least part of the second CSI is determined based on the value of the new parameter corresponding to the second CSI.

Optionally, the original parameters corresponding to the first CSI include the first original parameter y and the second original parameter k in the first priority determination formula.

Optionally, a first new parameter y′ corresponding to the second CSI may be added, where the first new parameter y′ is used to indicate the combination of time-domain characteristics and bearer channels during the reporting of the second CSI. Further, the value of the first new parameter y′ corresponding to the second CSI is determined. Optionally, the value of the first new parameter y′ may be a value in the predefined first candidate value set, or the value of the first new parameter y′ may be a new value outside the first candidate value set.

The second priority determination formula is shown in the following formula (2):

$${Pri}_{iCSI} ( {y}^{′} , y , k , c , s ) = α \cdot {N}_{cells} \cdot {M}_{x} \cdot {M}_{y} \cdot y + β \cdot {N}_{cells} \cdot {M}_{x} \cdot {M}_{y} \cdot k + γ \cdot {N}_{cells} \cdot {M}_{s} \cdot {y}^{′} + {M}_{s} \cdot c + s$$

Optionally, a second new parameter k′ corresponding to the second CSI may be added, where the second new parameter k′ is used to indicate the type of information reported in the second CSI. Further, the value of the first new parameter y′ corresponding to the second CSI is determined. Optionally, the value of the second new parameter k′ may be a value in the predefined second candidate value set, or the value of the second new parameter k′ may be a new value outside the second candidate value set.

The second priority determination formula may be shown in the following formula (3):

$${Pri}_{iCSI} ( y , {k}^{′} , k , c , s ) = α \cdot {N}_{cells} \cdot {M}_{s} \cdot {M}_{k} \cdot y + β \cdot {N}_{cells} \cdot {M}_{s} \cdot {M}_{k} \cdot k + γ \cdot {N}_{cells} \cdot {M}_{s} \cdot {k}^{′} + {M}_{s} \cdot c + s$$

where Mₖ, represents the number of beam management reports based on AI.

Optionally, a first new parameter y′ and a second new parameter k′ corresponding to the second CSI may be added. Optionally, the value of the first new parameter y′ may be a value in the predefined first candidate value set, or the value of the first new parameter y′ may be a new value outside the first candidate value set. Optionally, the value of the second new parameter k′ may be a value in the predefined second candidate value set, or the value of the second new parameter k′ may be a new value outside the second candidate value set.

The second priority determination formula may be shown in the following formula (4):

$${Pri}_{iCSI} ( {y}^{′} , y , {k}^{′} , k , c , s ) = α \cdot {N}_{cells} \cdot {M}_{s} \cdot y + β \cdot {N}_{cells} \cdot {M}_{s} \cdot y + γ \cdot {N}_{cells} \cdot {M}_{s} \cdot {k}^{′} + {N}_{cells} \cdot {M}_{s} \cdot k + {M}_{s} \cdot c + s$$

It should be noted that α, β and γ in the above formulas (2), (3), and (4) are all positive integers.

For illustrative purposes, if the CSI to be reported includes RI/CQI/CSI compression information based on AI, a beam index obtained based on AI methods, L1-RSRP obtained based on AI methods, and all L1-RSRP obtained based on traditional methods, that is, three CSI reports to be reported. Mₛ=3, meaning only three CSI are allowed to be reported. The reporting IDs of these four CSI are configured by the gNB as s=4, s=1, s=2, and s=3, respectively. The second CSI-related information obtained based on AI methods, such as RI/CQI/CSI compression information, may be reported to the network device through aperiodic CSI borne on PUSCH. Define k′=0 for the beam index reporting obtained based on AI methods, and k′=1 for the reporting of all beams obtained based on AI methods. Let the number of CSI reports for beam management obtained based on AI methods be M_{k′}=2. The beam reporting obtained based on traditional methods has k=0, and the second CSI-related information obtained based on AI methods, such as RI/CQI/CSI compression information reporting, has y=1; if there is only one serving cell, that is, N_{cells}=1, and they are reported within the same serving cell, and the index of the serving cell is 1.

Based on the second priority determination formula (3), where α=2, β=1 and γ=1, the reporting priority of the beam index obtained based on AI methods can be determined as: Pri_{iCSI}(y,k′,k,c,s)=21; based on the second priority determination formula (3), the reporting priority of all L1-RSRP obtained based on traditional methods can be determined as Pri_{iCSI}(y,k′,k,c,s)=26; based on the second priority determination formula (3), the reporting priority order of the first measurement parameter for beam management obtained based on traditional methods can be determined as Pri_{iCSI}(y,k′,k,c,s)=27; based on the second priority determination formula (3), the reporting priority order of the second CSI-related information obtained based on AI methods can be determined as Pri_{iCSI}(y,k′,k,c,s)=28.

In this example, the reporting priority order of the CSI to be reported is: the reporting priority of the beam index obtained based on AI methods is higher than that of all L1-RSRP obtained based on traditional methods; the reporting priority of all L1-RSRP obtained based on traditional methods is higher than that of the first measurement parameter for beam management; the reporting priority of the first measurement parameter for beam management is higher than that of the second CSI-related information.

S604: performing CSI reporting according to the reporting priority order.

In the embodiments of the present disclosure, after obtaining the priority order of the first CSI and the second CSI, the first CSI and/or the second CSI may be reported according to this priority order. In some embodiments, when there is a reporting conflict between the first CSI and the second CSI, CSI to be discarded may be determined from the first CSI and the second CSI based on the priority order, and the remaining CSI may be reported according to the reporting priority.

In some embodiments, when the number of CSI allowed to be reported is less than the number of CSI to be reported, CSI to be discarded may be determined from the first CSI and the second CSI based on the priority order, and the remaining CSI may be reported according to the reporting priority. Optionally, the terminal device may report the remaining CSI to the network device based on uplink transmission resources configured by the network device and according to the reporting priority of the remaining CSI.

In the embodiments of the present disclosure, during the process where the terminal device reports CSI to the network device, if there is a reporting conflict between the CSI obtained based on AI methods and the CSI obtained through traditional methods, part of the CSI may be determined to be discarded from the first CSI and/or the second CSI according to the reporting priority order of the first CSI and the second CSI, so as to solve the above reporting conflict problem, achieve the purpose of reasonably reporting CSI, and reduce the impact on system performance.

Please refer to FIG. 7, which is a schematic flowchart of another method for reporting CSI in an embodiment of the present disclosure. The method for reporting CSI may be performed by a network device. As shown in FIG. 7, the method may include, but is not limited to, the following steps:

S701: receiving CSI reported by a terminal device based on a reporting priority order.
where the reported CSI is at least part of first CSI and/or second CSI to be reported. In some embodiments, the first CSI includes at least one of the following information: a first measurement parameter for beam management, first CSI-related information, or L1 measurement parameters of all beams. The second CSI includes at least one of the following information: a second measurement parameter for beam management, second CSI-related information, or input information of an AI/ML model.

Optionally, the first CSI is CSI to be reported obtained based on traditional methods, and the second CSI is CSI to be reported obtained based on AI methods.

In some embodiments, the first CSI obtained based on traditional methods includes at least one of the following information:
a first measurement parameter for beam management obtained based on traditional methods;
first CSI-related information obtained based on traditional methods;
L1 measurement parameters of all beams obtained based on traditional methods.

Optionally, the first measurement parameter for beam management obtained based on traditional methods is one or more measurement parameters among the L1 measurement parameters of all beams obtained based on traditional methods. Optionally, the first measurement parameter may be a measurement parameter among the L1 measurement parameters that represents better signal quality. The first measurement parameter may include L1-RSRP and/or L1-SINR.

Optionally, the first CSI-related information obtained based on traditional methods may include one or more of: CQI, RI, or PMI.

Optionally, the L1 measurement parameters of all beams obtained based on traditional methods may include: L1-RSRP and/or L1-SINR corresponding to each CSI-RS.

In some embodiments, the second CSI obtained based on AI methods includes at least one of the following information:
a second measurement parameter for beam management obtained based on AI methods;
second CSI-related information obtained based on AI methods;
input information of an AI model when obtaining CSI based on AI methods.

Optionally, the second measurement parameter for beam management obtained based on AI methods is one or more measurement parameters among the L1 measurement parameters of all beams obtained based on traditional methods. Optionally, the second measurement parameter may be a measurement parameter among the L1 measurement parameters that represents better signal quality. The second measurement parameter may include L1-RSRP and/or L1-SINR. It can be understood that the second measurement parameter for beam management obtained based on AI methods is a result obtained through reasoning by the CSI generation model of the terminal device.

Optionally, the second CSI-related information obtained based on AI methods may include one or more of CQI, RI, or CSI compression information.

Optionally, the input information of the AI/ML model when obtaining CSI based on AI methods. Optionally, the input information may include, but is not limited to, downlink channel information H.

In the embodiments of the present disclosure, after the terminal device obtains the first CSI and the second CSI, it may determine the reporting priority order of at least part of the first CSI and the second CSI. After obtaining this priority order, the network device may receive the CSI reported by the terminal device according to this priority order.

In some embodiments, when there is a reporting conflict between the first CSI and the second CSI, the terminal device may determine CSI to be discarded from the first CSI and the second CSI based on the priority order. The CSI to be discarded may include one or more types of CSI in the first CSI, and/or one or more types of CSI in the second CSI. The network device may receive the remaining CSI reported by the terminal device according to the reporting priority. The remaining CSI may include one or more types of CSI in the first CSI, and/or one or more types of CSI in the second CSL

In some embodiments, the network device may configure uplink transmission resources for the terminal device, and the network device may receive the remaining CSI reported by the terminal device based on the configured uplink transmission resources.

In some embodiments, the network device may indicate to the terminal device the number of CSI allowed to be reported. The terminal device may determine whether there is an upload conflict between the first CSI and the second CSI based on the number of CSI reports and the number of CSI to be reported. If the number of CSI reports is less than the number of CSI to be reported, it indicates that there is an upload conflict between the first CSI and the second CSI, and then part of the CSI needs to be reasonably discarded according to the reporting priority order.

In some embodiments, the network device may indicate resources for uplink transmission to the terminal device, where the resources for uplink transmission are used to determine the number of CSI allowed to be reported.

In some embodiments, the terminal device may determine that the reporting priority of measurement parameters for beam management is higher than the reporting priority of the obtained CSI-related information.

In some embodiments, the terminal device may determine the reporting priority order among the first measurement parameter, the second measurement parameter, and the L1 measurement parameters of all beams according to a first set rule.

In some embodiments, the terminal device may determine the reporting priority order of the first CSI-related information, the second CSI-related information, and the input information of the AI/ML model according to a second set rule.

In some embodiments, the terminal device may determine the reporting priority of at least part of the first CSI and the second CSI based on a priority determination formula.

In some embodiments, the priority determination formula is a first priority determination formula, and the first CSI and the second CSI reuse the original parameters in the first priority determination formula. Determining the reporting priority of the first CSI and the second CSI based on the priority determination formula includes: determining the reporting priority of at least part of the first CSI based on the predefined value of the original parameter corresponding to the first CSI; determining the predefined value or a new value of the original parameter corresponding to the second CSI, and determining the reporting priority of at least part of the second CSI based on the predefined value or new value of the original parameter corresponding to the second CSL

In some embodiments, the value of the first original parameter y in the first priority determination formula is used to indicate different combinations of time-domain characteristics and bearer channels during CSI reporting; where the predefined value of the first original parameter y corresponding to the second CSI is a value in the predefined first candidate value set of the first original parameter y; or the new value of the first original parameter y corresponding to the second CSI is a value outside the first candidate value set.

In some embodiments, the value of the second original parameter k in the first priority determination formula is used to indicate the type of information reported in CSI; where the value of the second original parameter k corresponding to the second CSI is a value in the predefined second candidate value set of the second original parameter k; or the new value of the second original parameter k corresponding to the second CSI is a value outside the second candidate value set.

In some embodiments, the priority determination formula is a second priority determination formula, which includes the original parameters in the predefined first priority determination formula and new parameters added for the second CSI. Determining the reporting priority of at least part of the first CSI and the second CSI based on the priority determination formula includes: determining the value of the original parameter corresponding to the first CSI, and determining the reporting priority of at least part of the first CSI based on the value of the original parameter corresponding to the first CSI; determining the value of the new parameter corresponding to the second CSI, and determining the reporting priority of at least part of the second CSI based on the value of the new parameter corresponding to the second CSI.

Optionally, the original parameters corresponding to the first CSI include the first original parameter y and the second original parameter k in the first priority determination formula.

In some embodiments, a first new parameter y′ corresponding to the second CSI may be added, where the first new parameter y′ is used to indicate the combination of time-domain characteristics and bearer channels during the reporting of the second CSL.

In some embodiments, the terminal device may determine a second new parameter k′ corresponding to the second CSI, where the second new parameter k′ is used to indicate the type of information reported in the second CSI.

Optionally, a first new parameter y′ and a second new parameter k′ corresponding to the second CSI may be added.

In the embodiments of the present disclosure, during the process where the terminal device reports CSI to the network device, if there is a reporting conflict between the CSI obtained based on AI methods and the CSI obtained through traditional methods, part of the CSI may be determined to be discarded from the first CSI and/or the second CSI according to the reporting priority order of the first CSI and the second CSI, so as to solve the above reporting conflict problem, achieve the purpose of reasonably reporting CSI, and reduce the impact on system performance.

In the above embodiments provided by the present disclosure, the methods are described from the perspectives of the network device and the terminal device, respectively. To implement the various functions in the methods provided by the embodiments of the present disclosure, the network device and the terminal device may include hardware structures, software modules, or a combination of hardware structures and software modules to implement the above functions. Each of the above functions may be implemented by hardware structures, software modules, or a combination of hardware structures and software modules.

Please refer to FIG. 8, which is a schematic structural diagram of a communication apparatus 800 in an embodiment of the present disclosure. The communication apparatus 800 shown in FIG. 8 may include a transceiver module 801 and a processing module 802. The transceiver module 801 may include a sending module and/or a receiving module, where the sending module is used to implement sending functions, and the receiving module is used to implement receiving functions. The transceiver module 801 may implement sending and/or receiving functions.

The communication apparatus 800 may be a network device, an apparatus in a network device, or an apparatus that can be used in conjunction with a network device. Alternatively, the communication apparatus 800 may be a terminal device, an apparatus in a terminal device, or an apparatus that can be used in conjunction with a terminal device.

When the communication apparatus 800 is a terminal device:
The processing module 802 is used to obtain first CSI and second CSI to be reported and determine a reporting priority order of at least part of the first CSI and the second CSI;
The transceiver module 801 is used to perform CSI reporting according to the priority order.

In some embodiments, the first CSI includes at least one of the following information: a first measurement parameter for beam management, first CSI-related information, or L1 measurement parameters of all beams.

In some embodiments, the first CSI includes at least one of the following information:
a first measurement parameter for beam management obtained based on traditional methods;
first CSI-related information obtained based on traditional methods;
L1 measurement parameters of all beams obtained based on traditional methods.

In some embodiments, the second CSI includes at least one of the following information: a second measurement parameter for beam management, second CSI-related information, or input information of an AI/ML model.

In some embodiments, the second CSI includes at least one of the following information:
a second measurement parameter for beam management obtained based on AI methods;
second CSI-related information obtained based on AI methods;
input information of an AI/ML model when obtaining CSI based on AI methods.

In some embodiments, the reporting priority of measurement parameters for beam management is higher than the reporting priority of the obtained CSI-related information.

In some embodiments, the processing module 802 is further used to: determine the reporting priority order among the first measurement parameter, the second measurement parameter, and the L1 measurement parameters of all beams according to a first set rule.

In some embodiments, the processing module 802 is further used to: determine the reporting priority order of the first CSI-related information, the second CSI-related information, and the input information of the AI/ML model when obtaining CSI according to a second set rule.

In some embodiments, the processing module 802 is further used to: determine the reporting priority of at least part of the first CSI and the second CSI based on a set priority determination formula.

In some embodiments, the priority determination formula is a first priority determination formula, and the first CSI and the second CSI reuse the original parameters in the first priority determination formula. The processing module 802 is further used to: determine the reporting priority of at least part of the first CSI based on the predefined value of the original parameter corresponding to the first CSI; determine the predefined value or a new value of the original parameter corresponding to the second CSI, and determine the reporting priority of at least part of the second CSI based on the predefined value or new value of the original parameter corresponding to the second CSL

In some embodiments, the value of the first original parameter y in the first priority determination formula is used to indicate different combinations of time-domain characteristics and bearer channels during CSI reporting; the predefined value of the first original parameter y corresponding to the second CSI is a value in the predefined first candidate value set of the first original parameter y; or the new value of the first original parameter y corresponding to the second CSI is a value outside the first candidate value set.

In some embodiments, the value of the second original parameter k in the first priority determination formula is used to indicate the type of information reported in CSI, the value of the second original parameter k corresponding to the second CSI is a value in the predefined second candidate value set of the second original parameter k; or the new value of the second original parameter k corresponding to the second CSI is a value outside the second candidate value set.

In some embodiments, the priority determination formula is a second priority determination formula, which includes the original parameters in the first priority determination formula and new parameters added for the second CSI. The processing module 802 is further used to; determine the value of the original parameter corresponding to the first CSI, and determine the reporting priority of at least part of the first CSI based on the value of the original parameter corresponding to the first CSI; determine the value of the new parameter corresponding to the second CSI, and determine the reporting priority of at least part of the second CSI based on the value of the new parameter corresponding to the second CSL

In some embodiments, the processing module 802 is further used to: determine a first new parameter y′ corresponding to the second CSI, where the first new parameter y′ is used to indicate the combination of time-domain characteristics and bearer channels during the reporting of the second CSI

In some embodiments, the processing module 802 is further used to: determine a second new parameter k′ corresponding to the second CSI, where the second new parameter k′ is used to indicate the type of information reported in the second CSI.

In some embodiments, the processing module 802 is further used to: determine the number of CSI reports based on a protocol agreement, a network indication, or resources for uplink transmission; when the number of CSI reports is less than the number of CSI to be reported, determine CSI to be discarded and remaining CSI from the first CSI and the second CSI based on the reporting priority order;

In some embodiments, the transceiver module 801 is further used to: report the remaining CSI according to the reporting priority.

When the communication apparatus 800 is a network device:

The transceiver module 801 is used to receive CSI reported by a terminal device based on a reporting priority order, where the reported CSI is at least part of first CSI and/or second CSI to be reported.

In some embodiments, the first CSI includes at least one of the following information: a first measurement parameter for beam management, first CSI-related information, or L1 measurement parameters of all beams.

In some embodiments, the first CSI includes at least one of the following information:
a first measurement parameter for beam management obtained based on traditional methods;
first CSI-related information obtained based on traditional methods;
L1 measurement parameters of all beams obtained based on traditional methods.

In some embodiments, the second CSI includes at least one of the following information: a second measurement parameter for beam management, second CSI-related information, or input information of an AI/ML model.

In some embodiments, the second CSI includes at least one of the following information:
a second measurement parameter for beam management obtained based on AI methods;
second CSI-related information obtained based on AI methods;
input information of an AI/ML model when obtaining CSI based on AI methods.

In some embodiments, the transceiver module 801 is further used to: indicate the number of CSI reports to the terminal device; or indicate resources for uplink transmission to the terminal device, where the resources for uplink transmission are used to determine the number of CSI reports.

In the embodiments of the present disclosure, during the process where the terminal device reports CSI to the network device, if there is a reporting conflict between the CSI obtained based on AI methods and the CSI obtained through traditional methods, part of the CSI may be determined to be discarded from the first CSI and/or the second CSI according to the reporting priority order of the first CSI and the second CSI, so as to solve the above reporting conflict problem, achieve the purpose of reasonably reporting CSI, and reduce the impact on system performance.

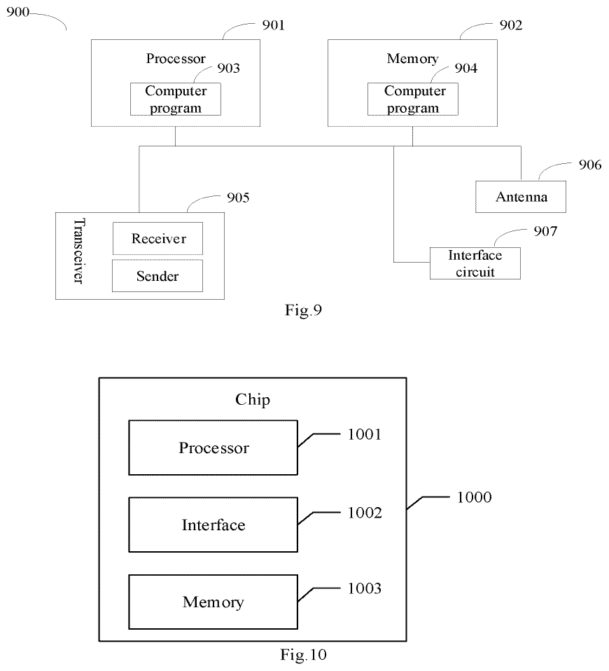

Please refer to FIG. 9, which is a schematic structural diagram of another communication apparatus 900 in an embodiment of the present disclosure. The communication apparatus 900 may be a network device, a terminal device, a chip, a chip system, or a processor that supports a network device to implement the above methods, or a chip, a chip system, or a processor that supports a terminal device to implement the above methods. The apparatus may be used to implement the methods described in the above method embodiments. For details, refer to the descriptions in the above method embodiments.

The communication apparatus 900 may include one or more processors 901. The processor 901 may be a general-purpose processor or a special-purpose processor, etc. For example, it may be a baseband processor or a central processing unit. The baseband processor may be used to process communication protocols and communication data, and the central processing unit may be used to control the communication apparatus (e.g., a base station, a baseband chip, a terminal device, a terminal device chip, a DU, or a CU, etc.), execute computer programs, and process data of the computer programs.

Optionally, the communication apparatus 900 may further include one or more memories 902, on which a computer program 904 may be stored. The processor 901 executes the computer program 904 to cause the communication apparatus 900 to perform the methods described in the above method embodiments, Optionally, data may also be stored in the memory 902. The communication apparatus 900 and the memory 902 may be set separately or integrated together.

Optionally, the communication apparatus 900 may further include a transceiver 905 and an antenna 906. The transceiver 905 may be called a transceiver unit, a transceiver, or a transceiver circuit, etc., and is used to implement transceiver functions. The transceiver 905 may include a receiver and a transmitter. The receiver may be called a receiver or a receiving circuit, etc., and is used to implement receiving functions; the transmitter may be called a transmitter or a transmitting circuit, etc., and is used to implement transmitting functions,

Optionally, the communication apparatus 900 may further include one or more interface circuits 907. The interface circuit 907 is used to receive code instructions and transmit them to the processor 901. The processor 901 runs the code instructions to cause the communication apparatus 90 to perform the methods described in the above method embodiments.

In an embodiment, the processor 901 may include a transceiver for implementing receiving and transmitting functions. For example, the transceiver may be a transceiver circuit, an interface, or an interface circuit. The transceiver circuit, interface, or interface circuit for implementing receiving and transmitting functions may be separate or integrated together. The above transceiver circuit, interface, or interface circuit may be used for reading and writing code/data, or may be used for transmitting or transferring signals.

In an embodiment, the processor 901 may store a computer program 903. The computer program 903 runs on the processor 901 to cause the communication apparatus 900 to perform the methods described in the above method embodiments. The computer program 903 may be solidified in the processor 901. In this case, the processor 901 may be implemented by hardware.

In an embodiment, the communication apparatus 900 may include circuits that implement the functions of sending, receiving, or communication in the foregoing method embodiments. The processor and transceiver described in the present disclosure may be implemented on an integrated circuit (IC), an analog IC, a radio frequency integrated circuit (RFIC), a mixed-signal IC, an application-specific integrated circuit (ASIC), a printed circuit board (PCB), an electronic device, etc. The processor and transceiver may also be manufactured using various IC process technologies, such as complementary metal-oxide-semiconductor (CMOS), n-type metal-oxide-semiconductor (NMOS), p-type metal-oxide-semiconductor (PMOS), bipolar junction transistor (BIT), bipolar CMOS (BICMOS), silicon germanium (SiGe), gallium arsenide (GaAs), etc.

The communication apparatus in the above embodiment descriptions may be a network device or a terminal device, but the scope of the communication apparatus described in the present disclosure is not limited thereto, and the structure of the communication apparatus is not limited by FIG. 9. The communication apparatus may be an independent device or part of a larger device. For example, the communication apparatus may be:
(1) an independent integrated circuit (IC), or a chip, or a chip system or subsystem;
(2) a set of one or more ICs, optionally, the set of ICs may also include storage components for storing data and computer programs;
(3) an ASIC, such as a modem (Modem);
(4) a module that can be embedded in other devices;
(5) a receiver, terminal device, smart terminal device, cellular phone, wireless device, handset, mobile unit, vehicle-mounted device, network device, cloud device, artificial intelligence device, etc.;
(6) others, etc.

For the case where the communication apparatus may be a chip or a chip system, refer to the schematic structural diagram of the chip shown in FIG. 10. The chip shown in FIG. 10 includes a processor 1001 and an interface 1002. The number of processors 1001 may be one or more, and the number of interfaces 1002 may be multiple.

Optionally, the chip further includes a memory 1003, which is used to store necessary computer programs and data.

In some embodiments, the chip may be used to implement the functions of the terminal device in the embodiments of the present disclosure:
The processor 1001 is used to obtain first CSI and second CSI to be reported and determine a reporting priority order of at least part of the first CSI and the second CSI;
The interface 1002 is used to perform CSI reporting according to the priority order.

In some embodiments, the first CSI includes at least one of the following information: a first measurement parameter for beam management, first CSI-related information, or L1 measurement parameters of all beams.

In some embodiments, the first CSI includes at least one of the following information:
a first measurement parameter for beam management obtained based on traditional methods;
first CSI-related information obtained based on traditional methods;
L1 measurement parameters of all beams obtained based on traditional methods.

In some embodiments, the second CSI includes at least one of the following information: a second measurement parameter for beam management, second CSI-related information, or input information of an AI/ML model

In some embodiments, the second CSI includes at least one of the following information:
a second measurement parameter for beam management obtained based on AI methods;
second CSI-related information obtained based on AI methods;
input information of an AI/ML model when obtaining CSI based on AI methods.

In some embodiments, the reporting priority of measurement parameters for beam management is higher than the reporting priority of the obtained CSI-related information.

In some embodiments, the processor 1001 is further used to: determine the reporting priority order among the first measurement parameter, the second measurement parameter, and the L1 measurement parameters of all beams according to a first set rule.

In some embodiments, the processor 1001 is further used to: determine the reporting priority order of the first CSI-related information, the second CSI-related information, and the input information according to a second set rule.

In some embodiments, the processor 1001 is further used to: determine the reporting priority of at least part of the first CSI and the second CSI based on a priority determination formula.

In some embodiments, the priority determination formula is a first priority determination formula, and the first CSI and the second CSI reuse the original parameters in the first priority determination formula. The processor 1001 is further used to: determine the reporting priority of at least part of the first CSI based on the predefined value of the original parameter corresponding to the first CSI; determine the predefined value or a new value of the original parameter corresponding to the second CSI, and determine the reporting priority of at least part of the second CSI based on the predefined value or new value of the original parameter corresponding to the second CSI.

In some embodiments, the value of the first original parameter y in the first priority determination formula is used to indicate different combinations of time-domain characteristics and bearer channels during CSI reporting; where the predefined value of the first original parameter y corresponding to the second CSI is a value in the predefined first candidate value set of the first original parameter y: or the new value of the first original parameter y corresponding to the second CSI is a value outside the first candidate value set.

In some embodiments, the value of the second original parameter k in the first priority determination formula is used to indicate the type of information reported in CSI; where the value of the second original parameter k corresponding to the second CSI is a value in the predefined second candidate value set of the second original parameter k; or the new value of the second original parameter k corresponding to the second CSI is a value outside the second candidate value set.

In some embodiments, the priority determination formula is a second priority determination formula, which includes the original parameters in the first priority determination formula and new parameters added for the second CSI. The processor 1001 is further used to: determine the value of the original parameter corresponding to the first CSI, and determine the reporting priority of at least part of the first CSI based on the value of the original parameter corresponding to the first CSI; determine the value of the new parameter corresponding to the second CSI, and determine the reporting priority of at least part of the second CSI based on the value of the new parameter corresponding to the second CSI.

In some embodiments, the processor 1001 is further used to: determine a first new parameter y′ corresponding to the second CSI, where the first new parameter y′ is used to indicate the combination of time-domain characteristics and bearer channels during the reporting of the second CSL

In some embodiments, the processor 1001 is further used to; determine a second new parameter k′ corresponding to the second CSI, where the second new parameter k′ is used to indicate the type of information reported in the second CSI.

In some embodiments, the processor 1001 is further used to: determine the number of CSI reports based on a protocol agreement, a network indication, or resources for uplink transmission; when the number of CSI reports is less than the number of CSI to be reported, determine CSI to be discarded and remaining CSI from the first CSI and the second CSI based on the reporting priority order;

In some embodiments, the interface 1002 is further used to: report the remaining CSI according to the reporting priority.

When the communication apparatus 800 is a network device:

The interface 1002 is used to receive CSI reported by a terminal device based on a reporting priority order, where the reported CSI is part of first CSI and/or second CSI to be reported.

In some embodiments, the first CSI includes at least one of the following information: a first measurement parameter for beam management, first CSI-related information, or L1 measurement parameters of all beams.

In some embodiments, the first CSI includes at least one of the following information:
a first measurement parameter for beam management obtained based on traditional methods;
first CSI-related information obtained based on traditional methods;
L1 measurement parameters of all beams obtained based on traditional methods.

In some embodiments, the second CSI includes at least one of the following information: a second measurement parameter for beam management, second CSI-related information, or input information of an AI/ML model.

In some embodiments, the second CSI includes at least one of the following information:
a second I measurement parameter for beam management obtained based on AI methods;
second CSI-related information obtained based on AI methods;
input information of an AI/ML model when obtaining CSI based on AI methods.

In some embodiments, the interface 1002 is further used to: indicate the number of CSI reports to the terminal device; or indicate resources for uplink transmission to the terminal device, where the resources for uplink transmission are used to determine the number of CSI reports.

In the embodiments of the present disclosure, during the process where the terminal device reports CSI to the network device, if there is a reporting conflict between the CSI obtained based on AI methods and the CSI obtained through traditional methods, part of the CSI may be determined to be discarded from the first CSI and/or the second CSI according to the reporting priority order of the first CSI and the second CSI, so as to solve the above reporting conflict problem, achieve the purpose of reasonably reporting CSI, and reduce the impact on system performance.

Those skilled in the art can also understand that the various illustrative logical blocks and steps listed in the embodiments of the present disclosure can be implemented by electronic hardware, computer software, or a combination of both. Whether such functions are implemented by hardware or software depends on the specific application and design constraints of the overall system. Those skilled in the art can use various methods to implement the described functions for each specific application, but such implementation should not be understood as beyond the scope of protection of the embodiments of the present disclosure.

The embodiments of the present disclosure also provide a system for reporting CSI, where the system includes the communication apparatus as a network device and the communication apparatus as a terminal device in the foregoing FIC. 9 embodiment, or the system includes the communication apparatus as a network device and the communication apparatus as a terminal device in the foregoing FIG. 10 embodiment.

The present disclosure also provides a readable storage medium having instructions stored thereon, which when executed by a computer, implement the functions of any of the foregoing method embodiments.

The present disclosure also provides a computer program product, which when executed by a computer, implements the functions of any of the foregoing method embodiments.

In the foregoing embodiments, the implementations may be entirely or partially achieved by software, hardware, firmware, or any combination thereof. When software is used for implementation, it may be entirely or partially implemented in the form of a computer program product. The computer program product includes one or more computer programs. When the computer programs are loaded and executed on a computer, the processes or functions described in the embodiments of this application are entirely or partially generated. The computer may be a general-purpose computer, a specialized computer, a computer network, or other programmable devices. The computer programs may be stored in a computer-readable storage medium or transmitted from one computer-readable storage medium to another. For example, the computer programs may be transmitted from a website, computer, server, or data center to another website, computer, server, or data center via wired means (e.g., coaxial cable, fiber optics, Digital Subscriber Line (DSL)) or wireless means (e.g., infrared, wireless, microwave, etc.). The computer-readable storage medium may be any available medium that can be accessed by a computer or a data storage device, such as a server or data center, that integrates one or more available media. The available medium may be a magnetic medium (e.g., floppy disk, hard disk, magnetic tape), an optical medium (e.g., Digital Video Disc (DVD)), or a semiconductor medium (e.g., Solid State Disk (SSD)), among others.

A person of ordinary skill in the art may understand that numerical references such as “first” and “second” in this application are merely used for distinguishing descriptions and do not limit the scope of the embodiments of this application, nor do they indicate any sequential order,

In this application, “at least one” may also be described as “one or more,” and “a plurality of” may refer to two, three, four, or more, which is not limited in this application. In the embodiments of this application, for a technical feature, distinctions are made using terms such as “first,” “second,” “third,” “A,” “B.” “C,” and “D” to differentiate between the technical features within that category. The terms “first,” “second,” “third,” “A,” “B,” “C,” and “D” do not imply any sequential or size order among the described technical features.

The correspondences shown in the tables in this application may be configured or predefined. The values of the information in the tables are merely examples and may be configured as other values, which is not limited in this application. When configuring the correspondences between configuration information and parameters, it is not necessary to configure all the correspondences illustrated in the tables. For example, some rows of correspondences shown in the tables of this application may not be configured. Alternatively, appropriate adjustments may be made based on the above tables, such as splitting, merging, etc. The parameter names shown in the headers of the above tables may also be replaced with other names understandable by communication devices, and the values or representations of the parameters may also be other values or representations understandable y communication devices. The above tables may be implemented using other data structures, such as arrays, queues, containers, stacks, linear lists, pointers, linked lists, trees, graphs, structs, classes, heaps, hash tables, or bash maps.

In this application, “predefined” may be understood as defined, pre-defined, stored, pre-stored, pre-negotiated, pre-configured, hardcoded, or pre-burned.

A person of ordinary skill in the art may recognize that the units and algorithm steps described in the examples of the embodiments disclosed herein can be implemented in electronic hardware, or a combination of computer software and electronic hardware. Whether these functions are performed by hardware or software depends on the specific application and design constraints of the technical solution. Professionals may use different methods for each specific application to implement the described functions, but such implementation should not be considered beyond the scope of this application.

Those skilled in the art may clearly understand that, for the convenience and brevity of description, the specific working processes of the systems, devices, and units described above may refer to the corresponding processes in the foregoing method embodiments and are not repeated here.

The foregoing is merely specific embodiments of this application, but the protection scope of this application is not limited thereto. Any person skilled in the art may easily think of changes or substitutions within the technical scope disclosed in this application, which shall be covered within the protection scope of this application. Therefore, the protection scope of this application shall be subject to the protection scope of the claims.

1. A method for reporting channel state information (CSI), performed by a terminal, comprising:
obtaining first CSI and second CSI to be reported;
determining a reporting priority order of at least part of the first CSI and the second CSI; and
performing a CSI reporting according to the reporting priority order.

2. The method according to claim 1, wherein the first CSI comprises at least one of:
a first measurement parameter for beam management;
first CSI-related information; or
L1 measurement parameters of all beams.

3. The method according to claim 1, wherein the second CSI comprises at least one of:
a second measurement parameter for beam management;
second CSI-related information; or
input information of an Artificial Intelligence (AI)/Machine Learning (ML) model for obtaining CSI.

4. The method according to claim 3, wherein a reporting priority of a measurement parameter for beam management is higher than a reporting priority of an obtained CSI-related information.

5. The method according to claim 3, further comprising:
determining the reporting priority order of the first measurement parameter, the second measurement parameter and the L1 measurement parameters of all beams according to a first predetermined rule.

6. The method according to claim 3, further comprising:
determining the reporting priority order of the first CSI-related information, the second CSI-related information and the input information according to a second predetermined rule.

7. The method according to claim 1, further comprising:
determining a reporting priority of at least part of the first CSI and the second CSI based on a priority determination formula.

8. The method according to claim 7, wherein the priority determination formula is a first priority determination formula, and the first CSI and the second CSI reuse an original parameter in the first priority determination formula;
wherein determining the reporting priority of the at least part of the first CSI and the second CSI based on the priority determination formula comprises:
determining a reporting priority of at least part of the first CSI based on a predefined value of the original parameter corresponding to the first CSI; and
determining a predefined value or a new value of the original parameter corresponding to the second CSI, and determining a reporting priority of at least part of the second CSI based on the predefined value or the new value of the original parameter corresponding to the second CSI.

9. The method according to claim 8, wherein a value of a first original parameter y in the first priority determination formula is used to indicate a combination of time-domain characteristic and bearer channel of a CSI, wherein
a predefined value of the first original parameter y corresponding to the second CSI is a value in a predefined first candidate value set of the first original parameter y; or
a new value of the first original parameter y corresponding to the second CSI is a value outside a predefined first candidate value set of the first original parameter y.

10. The method according to claim 8, wherein a value of a second original parameter k in the first priority determination formula is used to indicate a type of information reported in a CSI, wherein
a predefined value of the second original parameter k corresponding to the second CSI is a value in a predefined second candidate value set of the second original parameter k; or
a new value of the second original parameter k corresponding to the second CSI is a value outside a predefined second candidate value set of the second original parameter k.

11. The method according to claim 8, wherein the priority determination formula is a second priority determination formula, and the second priority determination formula comprises the original parameter in the first priority determination formula and a new parameter added for the second CSI, and determining the reporting priority of the at least part of the first CSI and the second CSI based on the priority determination formula comprises:
determining a value of the original parameter corresponding to the first CSI, and determining the reporting priority of the at least part of the first CSI based on the value of the original parameter corresponding to the first CSI; and
determining a value of the new parameter corresponding to the second CSI, and determining the reporting priority of the at least part of the second CSI based on the value of the new parameter corresponding to the second CSI.

12. The method according to claim 11, further comprising:
determining a first new parameter y′ corresponding to the second CSI, wherein the first new parameter y′ is used to indicate a combination of time-domain characteristic and bearer channel of the second CSI.

13. The method according to claim 11, further comprising:
determining a second new parameter k′ corresponding to the second CSI, wherein the second new parameter k′ is used to indicate a type of information reported in the second CSI.

14. The method according to claim 1, further comprising:
determining, based on a protocol agreement, a network indication or resources for uplink transmission, a quantity of pieces of CSI allowed to be reported;
in a case where the quantity of pieces of CSI allowed to be reported is less than a quantity of pieces of CSI to be reported, determining CSI to be discarded and remaining CSI from the first CSI and the second CSI based on the reporting priority order; and
reporting the remaining CSI according to the reporting priority order.

15. A method for reporting channel state information (CSI), performed by a network device, comprising:
receiving CSI reported by a terminal based on a reporting priority order, wherein the reported CSI is at least part of a first CSI and/or a second CSI to be reported.

16. The method according to claim 15, wherein the first CSI comprises at least one of:
a first measurement parameter for beam management;
first CSI-related information; or
L1 measurement parameters of all beams.

17. The method according to claim 15, wherein the second CSI comprises at least one of:
a second measurement parameter for beam management;
second CSI-related information; or
input information of an Artificial Intelligence (AI)/Machine Learning (ML) model for obtaining CSI.

18. The method according to claim 15, further comprising:
indicating, to the terminal, a quantity of pieces of CSI allowed to be reported; or
indicating resources for uplink transmission to the terminal, wherein the resources for uplink transmission are used to determine a quantity of pieces of CSI allowed to be reported.

19-20. (canceled)

21. A terminal, comprising a processor and a memory, wherein the memory stores a computer program, and the processor executes the computer program stored in the memory to cause the terminal to perform;
obtaining first CSI and second CSI to be reported;
determining a reporting priority order of at least part of the first CSI and the second CSI; and
performing a CSI reporting according to the reporting priority order.

22. A network device, comprising a processor and a memory, wherein the memory stores a computer program, and the processor executes the computer program stored in the memory to cause the network device to perform the method according to claim 15.

23-26. (canceled)
